(19) United States
(12) Patent Application Publication
(10) Pub. No.: US 2025/0086375 A1
(43) Pub. Date: Mar. 13, 2025

(54) Document Processing Method, and Information Processing Device

(71) Applicant: LEGALON TECHNOLOGIES, INC., Tokyo (JP)

(72) Inventors: Ruka FUNAKI, Tokyo (JP); Shinsuke MORI, Tokyo (JP); Kohei SUENAGA, Tokyo (JP); Yusuke NAGATA, Tokyo (JP)

(73) Assignee: LEGALON TECHNOLOGIES, INC., Tokyo (JP)

(21) Appl. No.: 18/952,229

(22) Filed: Nov. 19, 2024

Related U.S. Application Data
(63) Continuation of application No. 18/107,639, filed on Feb. 9, 2023, now Pat. No. 12,182,492.
Application No. 18/107,639 is a continuation of application No. PCT/JP2020/030589, filed on Aug. 11, 2020.

(51) Int. Cl. G06F 40/106; G06F 40/166

(52) U.S. Cl. CPC G06F 40/106; G06F 40/166

(57) ABSTRACT

A document processing method comprising: receiving document information from a terminal; and outputting associated information obtained by associating a subject element and a defining element with each other, and associating the defining element and a limiting element with each other based on the content of the document information, the subject element being a character string representing a subject extracted from a character string of the document information, the defining element being a character string defining an operation and/or a state of the subject, and the limiting element being a character string limiting a content of the defining element.

### CROSS-REFERENCE TO RELATED APPLICATION

The present application is a continuation of U.S. patent application Ser. No. 18/107,639, filed Feb. 9, 2023, now allowed, which is a bypass continuation application based on and claims the benefit of priority from PCT Application No. PCT/JP2020/030589 filed Aug. 11, 2020, the entire contents of which are incorporated herein by reference.

### TECHNICAL FIELD

The present disclosure relates to a document processing method, and an information processing device.

### BACKGROUND

As a conventional technique, an information processing device has been proposed that determines a possible risk of a sentence included in a contract, and assists in checking the contract (for example, see Japanese Patent Application Laid-Open No. 2012-208547).

In the information processing device disclosed in Japanese Patent Application Laid-Open No. 2012-208547, a sentence decomposing unit decomposes a sentence included in contract data, and extracts an object, a predicate, and a modifier included in the sentence, and if a combination of the extracted object and predicate is included in a signal object/signal predicate combination table and the extracted modifier is included in a signal modifier/risk table, a risk determination unit determines a risk corresponding to the modifier from the signal modifier/risk table.

### SUMMARY

An aspect of the invention according to the present disclosure is a document processing method comprising: receiving document information from a terminal; and outputting associated information obtained by associating a subject element and a defining element with each other, and associating the defining element and a limiting element with each other based on the content of the document information, the subject element being a character string representing a subject extracted from a character string of the document information, the defining element being a character string defining an operation and/or a state of the subject, and the limiting element being a character string limiting a content of the defining element.

### BRIEF DESCRIPTION OF DRAWINGS

FIG. 1 is a schematic view illustrating an exemplary configuration of a document processing system according to an embodiment.

FIG. 2 is a block diagram illustrating an exemplary configuration of a document processing server device 1 according to an embodiment.

FIG. 3 is a schematic view illustrating an exemplary structure of document information.

FIG. 4 is a schematic view illustrating an exemplary structure of element information.

FIG. 5 is a schematic view illustrating an exemplary structure of associated information.

FIG. 6 is a schematic view illustrating the structure of document information including annotations added thereto.

FIG. 7 is a schematic view illustrating the structure of document information including annotations added thereto.

FIG. 8 is a schematic view illustrating an exemplary display of a display control unit.

FIG. 9 is a schematic view illustrating an exemplary display of the display control unit.

FIG. 10 is a schematic view illustrating an exemplary display of the display control unit.

FIG. 11 is a schematic view illustrating an exemplary display of the display control unit.

FIG. 12 is a schematic view illustrating an exemplary display of the display control unit.

FIG. 13 is a flowchart illustrating an operation of associating elements with each other with the document processing server device.

### DESCRIPTION

According to the information processing device disclosed in Japanese Patent Application Laid-Open No. 2012-208547, although a risk is determined based on the signal object/signal predicate combination table and the signal modifier/risk table and is then presented to the user, information stored in the signal object/signal predicate combination table and the signal modifier/risk table are those registered in advance, and thus, information not registered in advance cannot be presented to the user, which may be problematic. Further, the information processing device disclosed in Japanese Patent Application Laid-Open No. 2012-208547 is configured to determine a risk, but cannot present information for grasping the content of a contract, which may be problematic.

In view of the foregoing conventional technique, an object of the present disclosure is to provide a document processing program, an information processing device, and a document processing method that are easier to use.

According to various embodiments of the present disclosure, a document processing program, an information processing device, and a document processing method that are easier to use can be provided.

### Embodiment

### (Configuration of Document Processing System)

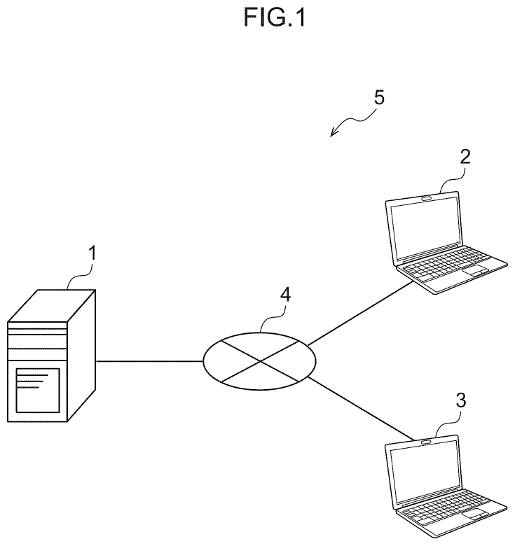

FIG. 1 is a schematic view illustrating an exemplary configuration of a document processing system according to an embodiment.

A document processing system 5 may include a document processing server device 1, a terminal 2, and a terminal 3 that are connected via a network 4 in a communicable manner. The terminal 2 may be operated by a user who wants to create, check, and/or review a document, for example, and the terminal 3 may be operated by another user who wants to create, check, and/or review the document. The user of the terminal 2 and the user of the terminal 3 may handle a contract as document information, for example, and repeatedly check, modify, and approve the content of the contract until they reach an agreement. The document processing system 5 may be mainly used for one of the users to grasp the content of document information created by the other user during the checking operation. The document processing system 5 may also be used for one of the users to check the content of document information created by himself/herself.

The document processing server device 1 may be a server-type information processing device that operates in response to requests from the terminal 2 and the terminal 3, and may include electronic components, such as a CPU (Central Processing Unit) with a function of processing information, an HDD (Hard Disk Drive), and a flash memory, within the body of the document processing server device 1. The document processing server device 1 may be a plurality of information processing devices that operate in a cooperative manner, or may be an information processing device operated through a given cloud service. Alternatively, the function of the document processing server device 1 may be implemented within the terminal 2 and/or the terminal 3.

Each of the terminal 2 and the terminal 3 may be an information processing device, such as a PC (Personal Computer) or a tablet terminal, and include electronic components, such as a CPU with a function of processing information and a flash memory, within the body of the terminal.

The network 4 may be a communication network that allows for high-speed communication, and is a wired communication network, such as the Internet, intranet, or LAN (Local Area Network); or a wireless communication network, for example.

In such a configuration, for example, a document to be processed by the document processing server device 1 is a document in the legal field, such as a contract, and one or both of the users is a person who is not a legal expert but needs to create a contract, or a person who is a legal expert, such as a lawyer, and has the knowledge of creating contracts. Alternatively, one or both of the users is a staff member of a sales department in a company or a staff member of a legal department in a company, for example.

An example of the basic operation is as follows. First, the terminal 2 or the terminal 3 may upload document information to the document processing server device 1. Then, the terminal 2 and the terminal 3 may request the document processing server device 1 to analyze the content of the document information therein, and then may check the results of analysis on the display units of the terminal 2 and the terminal 3.

In the present embodiment, the document processing server device 1 may mainly extract from document information the ranges of character strings as element information, and may associate the elements of the element information with each other based on the content of the document information, and then may present information on the relationship between the elements to one or both of the users. The elements of the element information herein may include a subject element that is a character string representing the subject of a sentence, a defining element that is a character string (which is often a verb phrase or a predicate, but there may also be other cases) defining the operation and/or the state of the subject, and a limiting element that is a character string limiting the operation and/or the state of the defining element. When the document information is a contract, for example, the subject element may be a party concerned et al. (which may include a third party or an uncertain person) who makes a contract, and the defining element may be a right of the party concerned, an obligation with which the party concerned should comply, prohibition (i.e., non-possession of rights), exemption from liability (i.e., non-possession of obligations), compensation for damages included in an obligation, or the like. The limiting element is a condition, an exception, a period (i.e., a duration), or the like that limits the content of the right, the obligation, or the like.

The party concerned may be a person with a proper name as a subject (which may also be an uncertain person without a proper name). The obligation may include a maximum of one verb phrase including a phrase “must do . . . ,” “should do . . . ,” or “is to do . . . ” at the beginning, for example (if a plurality of verb phrases are connected with a conjunction, the respective phrases may be separated). The right may include a maximum of one verb phrase including a word or a phrase “can,” “may,” or “be allowed to” at the beginning, for example (if a plurality of verb phrases are connected with a conjunction, the respective phrases may be separated). Each of the obligation and the right may include a grammatical unit other than a verb phrase as long as such a grammatical unit may define the operation and/or the state of the subject. The condition may include one or more clauses including a phrase “when . . . ,” “if . . . ,” or “in the case . . . ” at the beginning, for example. The exception may include one or more clauses including a phrase “this shall not apply when . . . ” or “except when . . . ” at the beginning, for example. Embodiments will be described hereinafter.

Although one terminal 2 and one terminal 3 are illustrated in the drawing, more than one terminal 2 and more than one terminal 3 may be connected to the network 4. Similarly, more than one user may operate each of such terminals.

### (Configuration of Document Processing Server Device)

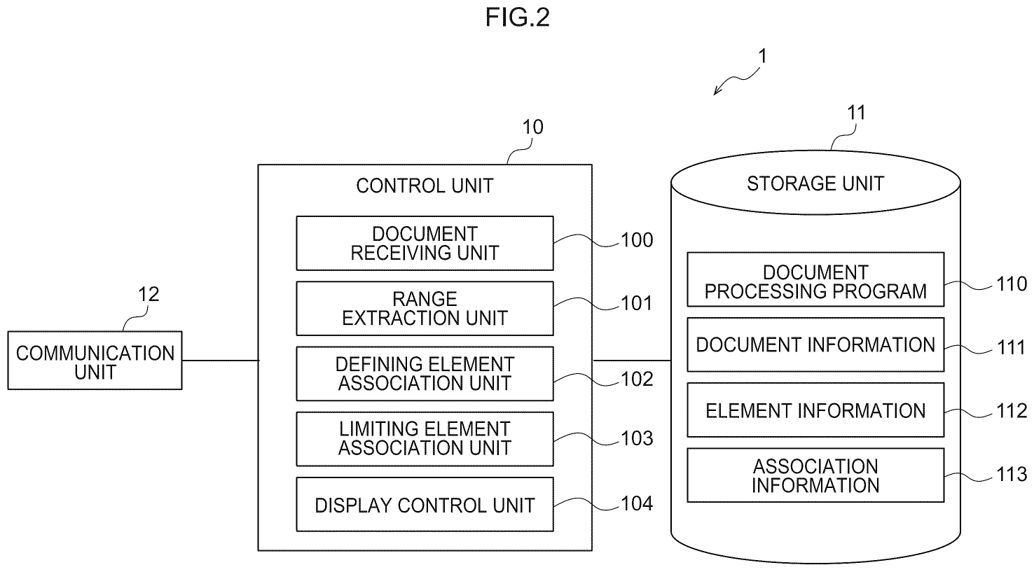

FIG. 2 is a block diagram illustrating an exemplary configuration of the document processing server device 1 according to an embodiment.

The document processing server device 1 may include a control unit 10, which includes a CPU and the like, and controls each unit and also executes various programs; a storage unit 11, which includes a storage medium, such as a flash memory, and stores information; and a communication unit 12 functioning as a communication interface for communicating with the outside via the network 4.

The control unit 10 may include a processor, such as a CPU, and may electrically connected to the storage unit 11 including the memory and to the communication unit 12 functioning as the communication interface. The control unit 10 may function as a document receiving unit 100, a range extraction unit 101, a defining element association unit 102, a limiting element association unit 103, a display control unit 104, and the like by executing a document processing program 110 described below.

The document receiving unit 100 may receive a contract as the document information 111 from the terminal 2 or the terminal 3, and then may store the contract in the storage unit 11.

The range extraction unit 101 may extract from a character string of the document information 111 a subject element that is the range of a character string representing a subject, a defining element that is the range of a character string defining the operation and/or the state of the subject, and a limiting element that is the range of a character string limiting the operation and/or the state of the defining element, and then may store the extracted elements as element information 112 in the storage unit 11. Specific examples of the extraction will be described later.

The defining element association unit 102 may associate, among the elements of the element information 112, the subject element and the defining element with each other based on the content of the document information 111, and may record the resulting information as associated information 113. Specific examples of the association will be described later.

The limiting element association unit 103 may associate, among the elements of the element information 112, the defining element and the limiting element with each other based on the content of the document information 111, and may record the resulting information as the associated information 113. Specific examples of the association will be described later.

The display control unit 104 may display the document information 111, the element information 112, and the associated information 113 in the storage unit 11 as well as the output result of each of the units 100 to 103 on the display units of the terminal 2 and the terminal 3 in a controlled manner, using a predetermined method. The display method will be described in detail later.

The storage unit 11 may include a memory, such as a flash memory, and may be electrically connected to the control unit 10 including the processor and the like and to the communication unit 12 functioning as the communication interface. The storage unit 11 may store the document processing program 110, which allows the control unit 10 to operate as each of the foregoing units 100 to 104, the document information 111, the element information 112, the associated information 113, and the like.

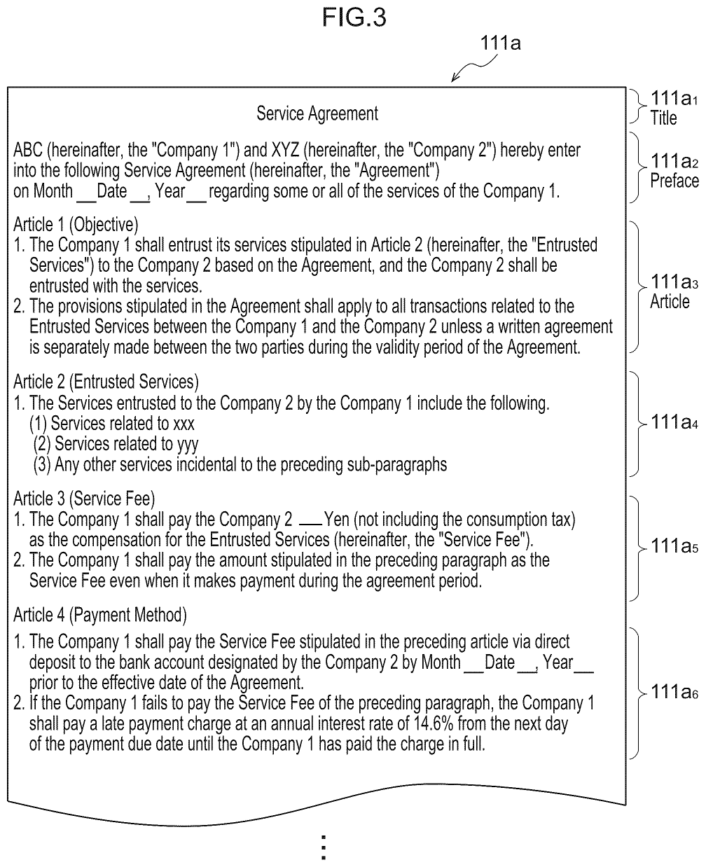

FIG. 3 is a schematic view illustrating an exemplary structure of the document information 111.

Document information 111a may be a contract, for example, and may include a title 111a₁, a preface 111a₂, and a plurality of articles (i.e., article units) 111a₃, 111a₄, 111a₅, 111a₆ . . . . Each of the articles (i.e., article units) 111a₃, 111a₄, 111a₅, 111a₆ . . . may include a plurality of further smaller units, such as paragraphs and sub-paragraphs, obtained through splitting. The document information 111a may also be parse based on a plurality of units according to the content of the contract.

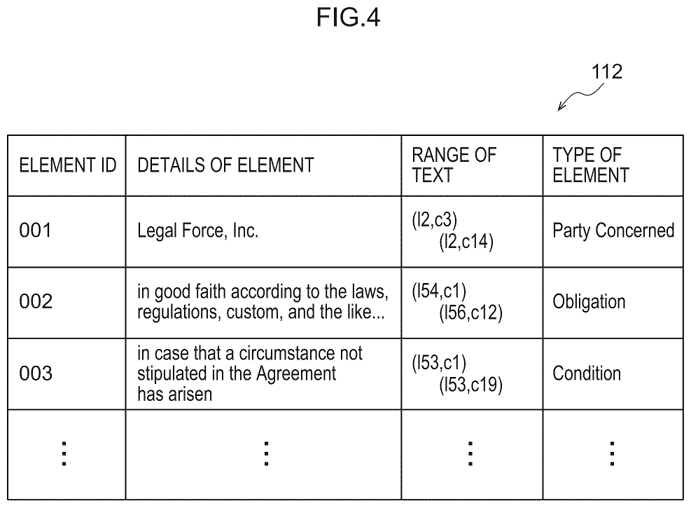

FIG. 4 is a schematic view illustrating an exemplary structure of the element information 112.

The element information 112 may include the element ID for identifying an element, the details of the element, the range of text indicating the positional information of the element in the document information 111, and the type of the element indicating which type (e.g., a party concerned, an obligation, a right, or a condition) the element belongs.

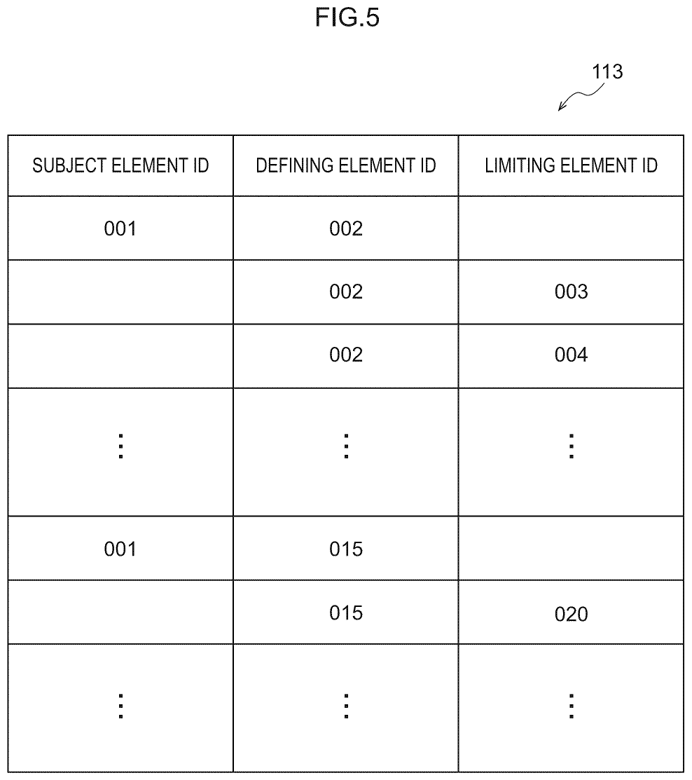

FIG. 5 is a schematic view illustrating an exemplary structure of the associated information 113.

The associated information 113 may include a subject element ID as the element ID of a subject element, a defining element ID as the element ID of a defining element, and a condition element ID as the element ID of a condition element. The associated information 113 may include an item of the element information 112 instead of or in addition to each ID.

Next, operations in a first embodiment, which include (1) a basic operation, (2) an operation of extracting information, and (3) an operation of displaying the extracted information, will be individually described. Hereinafter, an operation performed with the terminal 2 will be described, and if a similar operation is performed when the terminal 2 is replaced with the terminal 3, the description of such operation will be omitted.

### (1) Basic Operation

First, a user may operate the terminal 2 to log into a service provided by the document processing server device 1. The terminal 2, upon receiving an input of information, such as a user ID and password, from the user, may send to the document processing server device 1 the information as well as an authentication request.

The document processing server device 1, upon receiving the information, such as the user ID and password, as well as the authentication request from the terminal 2, may refer to user information including user IDs and passwords registered in advance so as to authenticate the requester as the user.

(2) Operation of Associating Elements with Each Other

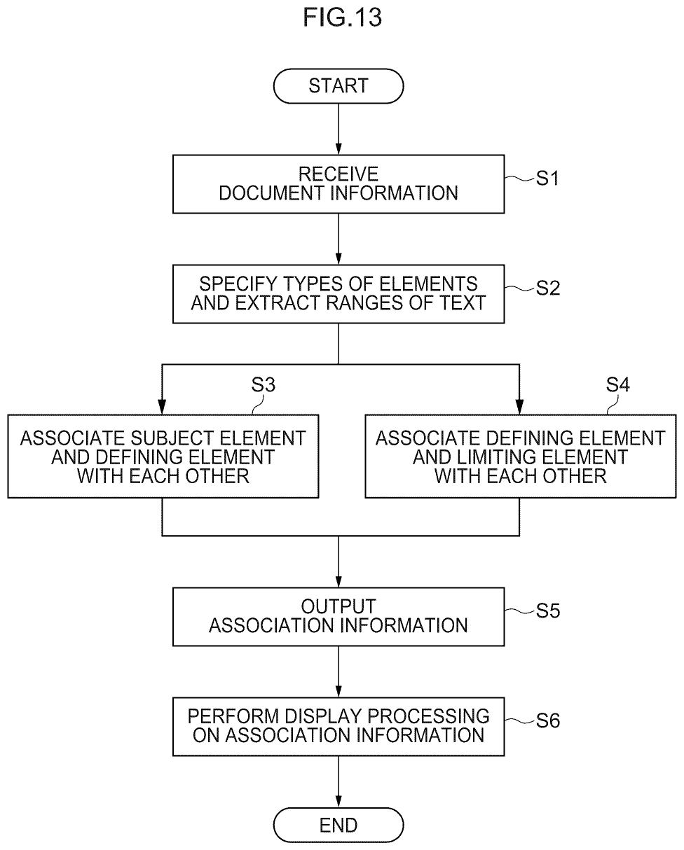

FIG. 13 is a flowchart illustrating an operation of associating elements with each other with the document processing server device 1 of the present embodiment.

Next, the user, upon logging into the service, may operate the terminal 2 to upload document information of a contract to the document processing server device 1. Then, the terminal 2 may upload the document information to the document processing server device 1.

The document receiving unit 100 of the document processing server device 1 may receive the document information 111 from the terminal 2 operated by the requester, and then may store the document information 111 in the storage unit 11 (S1).

Next, the user may operate the terminal 2 to select the desired document information 111 to be analyzed from the uploaded document information 111. The terminal 2 may send a request to the document processing server device 1 to analyze the document information 111.

The range extraction unit 101 of the document processing server device 1, upon receiving the request to analyze the document information 111, may extract from a character string of the document information 111 a subject element that is a character string representing a subject, a defining element that is a character string defining the operation and/or the state of the subject, and a limiting element that is a character string limiting the operation and/or the state of the defining element, and then may store the extracted elements as the element information 112 in the storage unit 11 (S2). The extraction may be performed by, for example, setting a party concerned as the subject element, setting a right and an obligation as the defining element, and setting a condition and an exception as the limiting element, and then performing prediction using a BIO (Begin-Inside-Outside) label learned with a BILSTM-CRF (Bidirectional Long Short Term Memory-Conditional Random Field). For example, machine learning based on a CRF (Conditional Random Field) or the like, or a rule-based method may be used.

For example, as illustrated in FIG. 4, the element information 112, which has been obtained by identifying the range of text (e.g., the range defined by the paragraph number, the line number, or the character number) in the document information 111 and the type of each element, may be extracted. For example, a description “LegalForce, Inc.” may be extracted from the range of text: line 2, the third character to line 2, the 14th character of the document information 111, and may be identified as a party concerned element as the subject element. In addition, a description “in good faith according to the laws, regulations, custom, and the like . . . ” may be extracted from the range of text: line 54, the 1st character to line 56, the 12th character of the document information 111, and may be identified as an obligation element as the defining element. Further, a description “in case that a circumstance not stipulated in the Agreement has arisen” may be extracted from the range of text: line 53, the 1st character to line 53, the 19th character of the document information 111, and may be identified as a condition element as the limiting element.

Next, the defining element association unit 102 of the document processing server device 1 may associate, among the elements of the element information 112, the subject element and the defining element with each other, and may record the resulting information as the associated information 113 (S3). Subject elements and defining elements may have a many-to-many relationship (i.e., a group of parties concerned vs. a group of rights/obligations). Thus, logistic regression may be used, for example, and binary classification may be performed on all combinations to perform association. If many-to-many association is possible, other association methods, such as a search technique, may be used.

In addition, the limiting element association unit 103 of the document processing server device 1 may associate, among the elements of the element information 112, the defining element and the limiting element with each other, and then may record the resulting information as the associated information 113 (S4). Defining elements and limiting elements may have a many-to-many relationship (i.e., a group of rights/obligations vs. a group of conditions/exceptions). Thus, logistic regression may be used, for example, and binary classification may be performed on all combinations to perform association. If many-to-many association is possible, other association methods, such as a search technique, may be used.

A pruning process may be performed in the process of associating the defining element and the limiting element with each other. The pruning process may be performed based on the number of characters, an article, a paragraph, a sub-paragraph, a line, a sentence, or the like as a unit, and if the distance between the character positions of the elements is determined to be longer than a predetermined distance based on the unit, association may not be performed on such elements. Further, the pruning process may also be performed in the process of associating the subject element and the defining element with each other. Either one of step S3 or step S4 may precede the other, or the steps may be performed at the same time.

For example, as illustrated in FIG. 5, the associated information 113, which defines the relationship between the respective elements, may be recorded. For example, text “LegalForce, Inc.” corresponding to the subject element ID “001” and text “in good faith according to the laws, regulations, custom, and the like . . . ” corresponding to the defining element ID “002” may be associated with each other, and the text “in good faith according to the laws, regulations, custom, and the like . . . ” corresponding to the defining element ID “002” and text “in case that a circumstance not stipulated in the Agreement has arisen” corresponding to the limiting element ID “003” may be associated with each other.

The associated information 113 may be represented not in a table form like the one illustrated in FIG. 5 but in a form obtained by adding annotations to the document information 111, for example. The following annotations may include “P” representing a party concerned, “R” representing a right, “O” representing an obligation, “C” representing a condition, and “E” representing an exception.

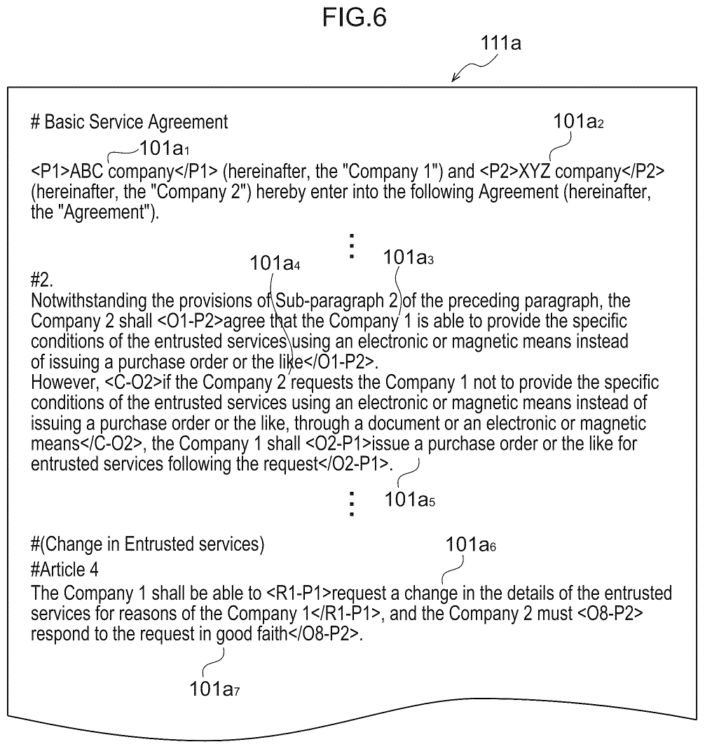

FIG. 6 is a schematic view illustrating an example of structure of the document information 111 including annotations added thereto.

“<P1>” and “</P1>” added to the start point and the end point, respectively, of a range 101a₁ may be annotations indicating a first subject element. “<P2>” and “</P2>” added to the start point and the end point, respectively, of a range 101a₂ may be annotations indicating a second subject element.

“<O1-P2>” and “</O1-P2>” added to the start point and the end point, respectively, of a range 101a₃ may be annotations indicating a first obligation-defining element associated with the second subject element. “<C-O2>” and “</C-O2>” added to the start point and the end point, respectively, of a range 101a₄ may be annotations indicating a limiting element associated with the second defining element. “<O2-P1>” and “</O2-P1>” added to the start point and the end point, respectively, of a range 101a₅ may be annotations indicating a second obligation-defining element associated with the first subject element.

“<R1-P1>” and “</R1-P1>” added to the start point and the end point, respectively, of a range 101a₆ may be annotations indicating a first right-defining element associated with the first subject element. “<08-P2>” and “</O8-P2>” added to the start point and the end point, respectively, of a range 101a₇ may be annotations indicating an eighth obligation-defining element associated with the second subject element.

Annotations can be similarly inserted into contracts written in languages other than Japanese. For example, annotations may be added to a contract written in English as follows.

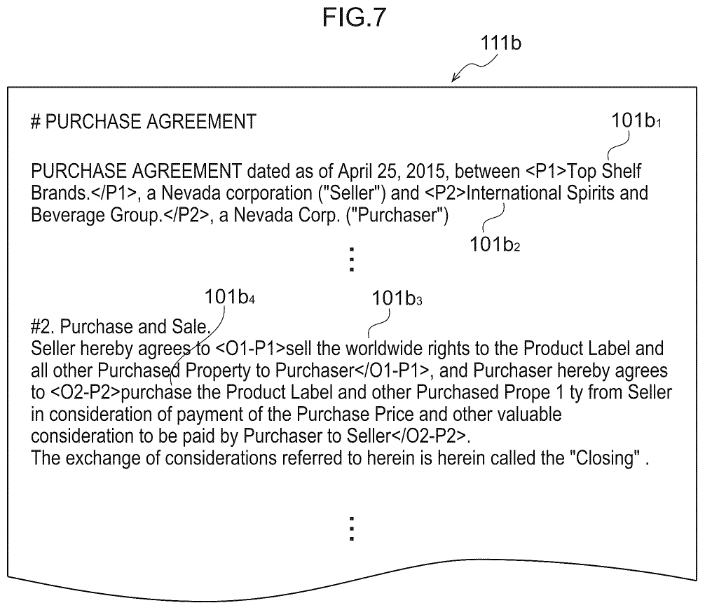

FIG. 7 is a schematic view illustrating an example of structure of the document information 111 including annotations added thereto.

“<P1>” and “</P1>” added to the start point and the end point, respectively, of a range 101b₁ may be annotations indicating a first subject element. “<P2>” and “</P2>” added to the start point and the end point, respectively, of a range 101b₂ may be annotations indicating a second subject element.

“<01-P1>” and “</O1-P1>” added to the start point and the end point, respectively, of a range 101b₃ may be annotations indicating a first obligation-defining element associated with the first subject element. “<O2-P2>” and “</O2-P2>” added to the start point and the end point, respectively, of a range 101b₄ may be annotations indicating a second obligation-defining element associated with the second subject element.

Next, the document processing server device 1 may output the associated information 113 to the display control unit 104 (S5). The document processing server device 1 may output the associated information 113 to the outside, and the output associated information 113 may be used by an external device.

Next, the display control unit 104 may perform display processing on the associated information 113, for example, and may display a screen like the one described below on the display unit of the terminal 2 (S6).

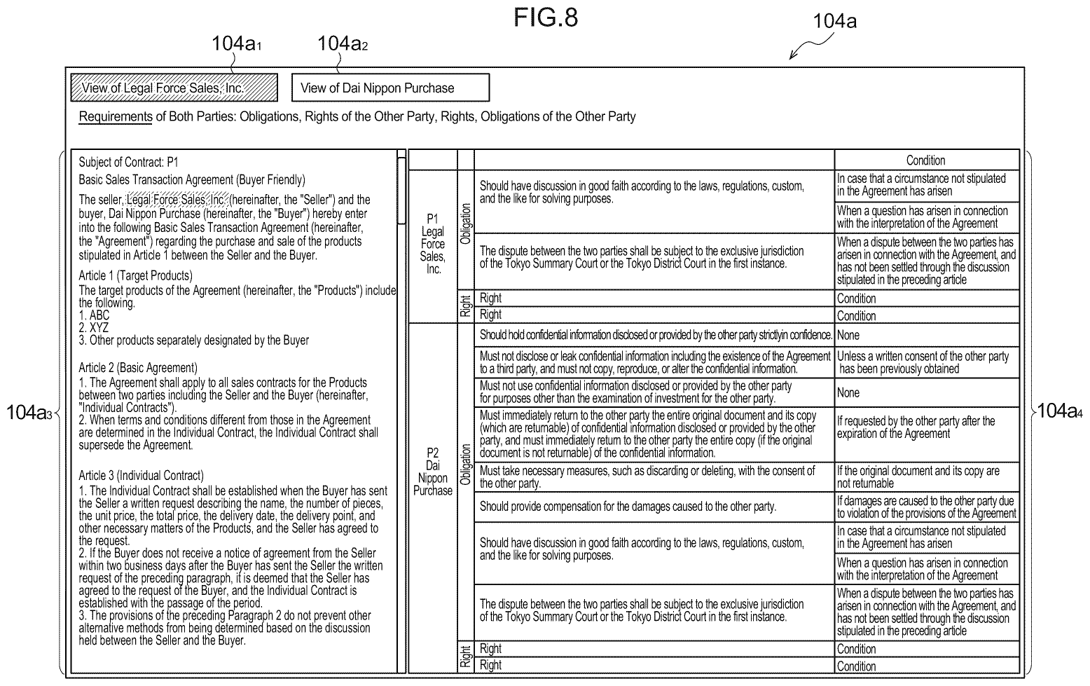

FIG. 8 is a schematic view illustrating an exemplary display of the display control unit 104.

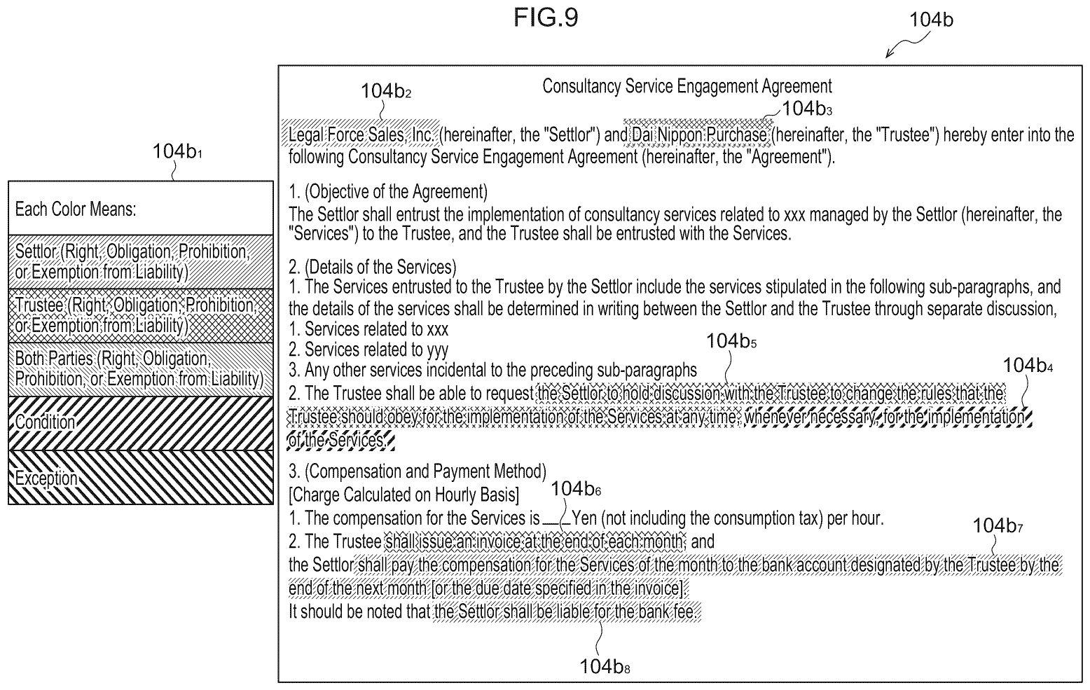

A screen 104a may include buttons 104a₁ and 104a₂ for switching a party concerned, a display field 104a₃ for displaying the content of the document information 111, and a display field 104a₄ for displaying the content of the associated information 113 in a table form. The display field 104a₃ may have an emphasized display function such as those illustrated in FIGS. 9 to 12 described below.

The display field 104a₄ may display, for each subject element (a party concerned 1 or 2), a defining element (i.e., an obligation or a right) associated with the subject element, and a limiting element (i.e., a condition) associated with each defining element, and may display the relationship between the respective elements in a list form.

As another example, the display control unit 104 may perform display processing on the associated information 113, and may display a screen like the one described below on the display unit of the terminal 2.

FIG. 9 is a schematic view illustrating an exemplary display of the display control unit 104.

A screen 104b may include a legend block 104b₁ including legends shown in different colors (which are expressed as different types of hatching for convenience's sake of the patent drawing), for example, and also may include a party concerned 104b₂ as a settlor, a party concerned 104b₃ as a trustee, a condition 104b₄, a defining element 104b₅ of the trustee, a defining element 104b₆ of the trustee, a defining element 104b₇ of the settlor, and a defining element 104b₈ of the settlor, each highlighted in a different color in contrast to the content of the document information 111 displayed in a text form. Each element may be displayed in a different font, a different size, a different type of hatching, italic font, underline, or rubi characters, for example, other than the different color.

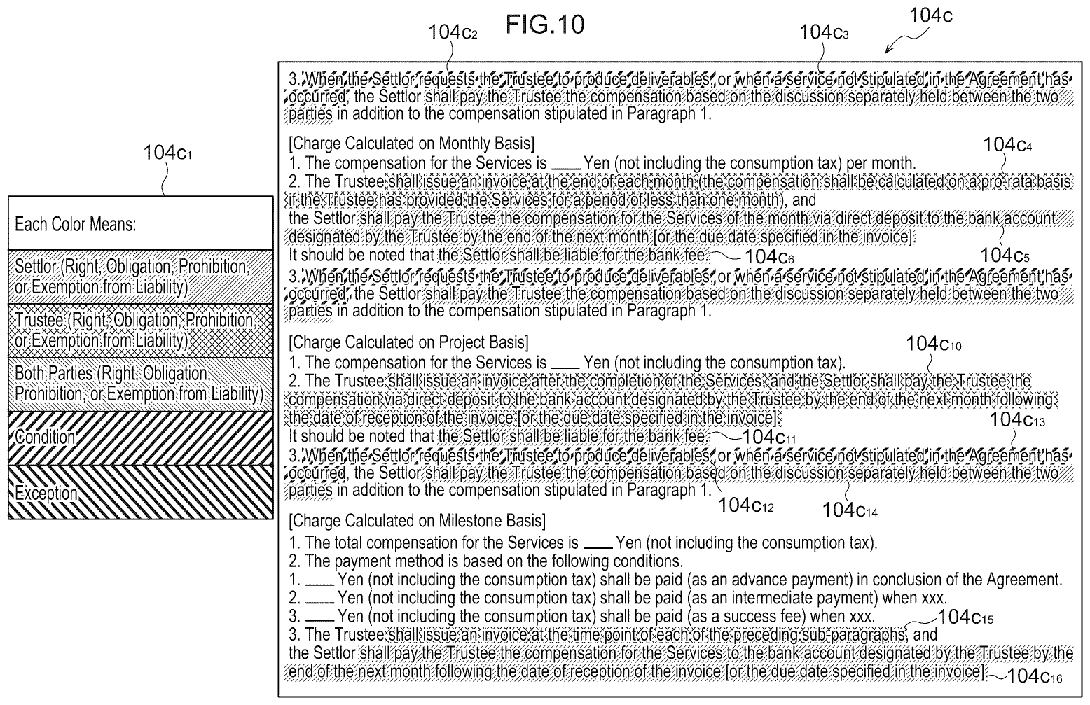

FIG. 10 is a schematic view illustrating an exemplary display of the display control unit 104.

A screen 104c may include a legend block 104c₁ including legends shown in different colors, for example, and also includes a condition 104c₂, an obligation 104c₃ of a settlor, an obligation 104c₄ of a trustee, obligations 104c₅ and 104c₆ of the settlor, conditions 104c₇ and 104c₈, an obligation 104c₉ of the settlor, an obligation 104c₁₀ of the trustee, an obligation 104c₁₁, of the settlor, conditions 104c₁₂ and 104c₁₃, an obligation 104c₁₄ of the settlor, an obligation 104c₁₅ of the trustee, and an obligation 104c₁₆ of the settlor, each highlighted in contrast to the content of the document information 111 displayed in a text form.

In each of the screens 104b and 104c, each element may be displayed in a different color in contrast to the document information 111 so that the relationship between the respective elements in the document information 111 is clarified.

As another example, the display control unit 104 may perform display processing on the associated information 113, and may display a screen like the one described below on the display unit of the terminal 2. The following example is different from FIG. 9 and FIG. 10 described above in that more specific legends are used.

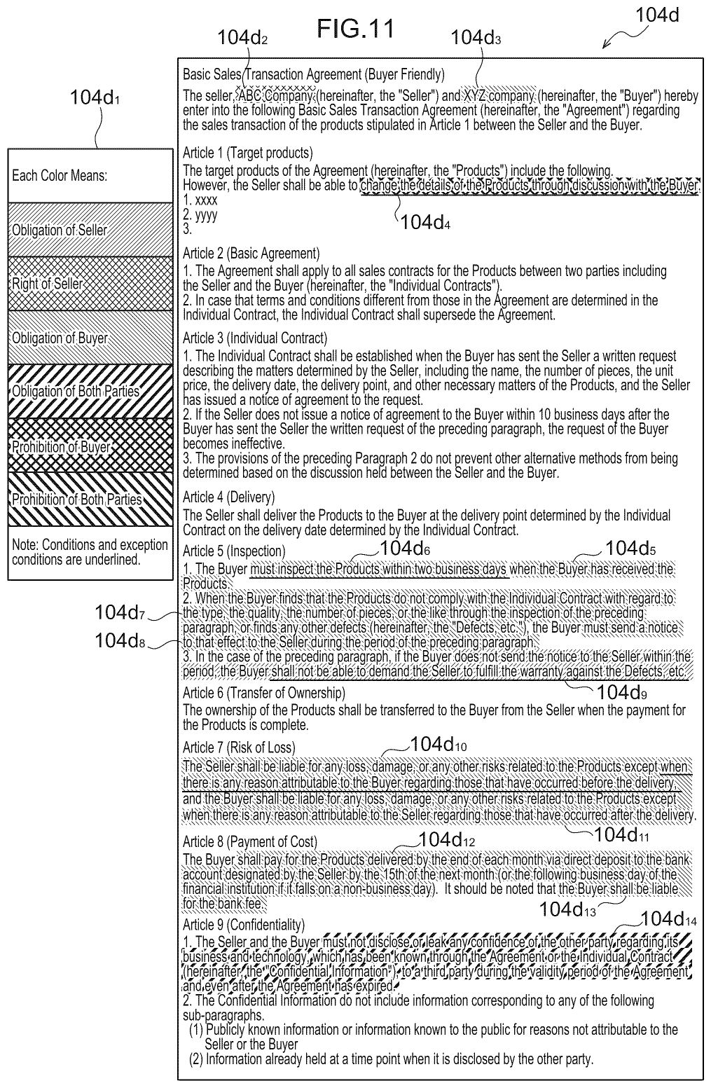

FIG. 11 is a schematic view illustrating an exemplary display of the display control unit 104.

A screen 104d may include a legend block 104d₁ including legends shown in different colors, for example, and may also include a party concerned 104d₂ as a seller; a party concerned 104d₃ as a buyer, an obligation 104d₄ of the two parties, obligations 104d₅, 104d₆, 104d₇ and 104d₈ of the buyer, an obligation 104d₉ of the seller, obligations 104d₁₀ and 104d₁₁ of the buyer, obligations 104d₁₂ and 104d₁₃ of the buyer, and an obligation 104d₁₄ of the two parties, each highlighted in contrast to the content of the document information 111 displayed in a text form. Conditions and exception conditions included in the rights and the obligations may be underlined.

The screen 104d may include more specific elements in comparison with the screens 104b and 104c, and the respective elements may be displayed in different colors in contrast to the document information 111 so that the relationship between the respective elements in the document information 111 is clarified.

As another example, the display control unit 104 may perform display processing on the associated information 113, and may display a screen like the one described below on the display unit of the terminal 2.

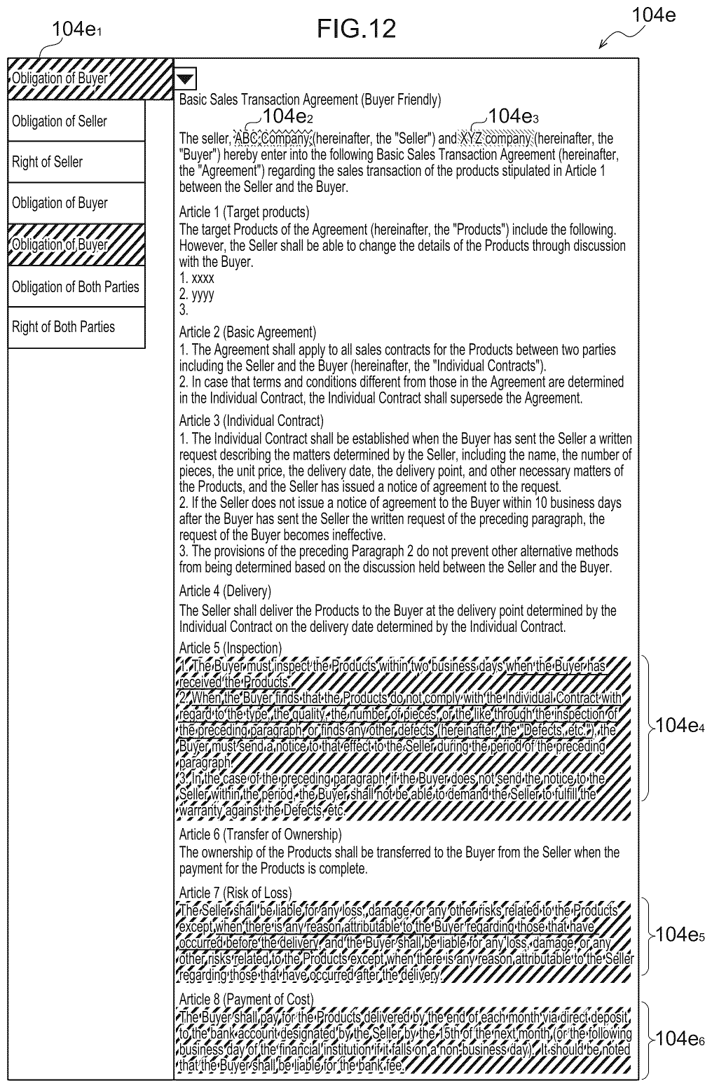

FIG. 12 is a schematic view illustrating an exemplary display of the display control unit 104.

A screen 104e may include a pull-down menu 104e₁ for selecting a desired item to be highlighted, a party concerned 104e₂ as a seller, a party concerned 104e₃ as a buyer, and obligations 104e₄, 104e₅, and 104e₆ of the buyer that are highlighted in contrast to the content of the document information 111 displayed in a text form when “Obligation of Buyer” is selected.

In the screen 104e, the selected element “Obligation of Buyer” may be highlighted in an emphasized manner in contrast to the document information 111 so that the relationship between the respective elements in the document information 111 is clarified. Conditions included in the highlighted display may be underlined. In addition, conditions and exception conditions included in the rights and the obligations may be underlined.

### Advantageous Effects of Embodiment

According to the foregoing embodiment, a subject element, a defining element, and a limiting element may be extracted from the document information 111, and the extracted subject element, defining element, and limiting element may be associated with each other based on the content of the document information 111 so that the associated information 113 may be obtained, and then, the associated information 113 may be displayed in a controller manner in a table form or through marking, for example. Therefore, even when a word not corresponding to information registered in advance is used, it is possible to present information for grasping the content of a contract. Since contracts are written in a form including sentences, certain knowledge and experience have been required to grasp the types of rights and obligations that each party concerned has as well as the types of conditions included in the rights and the obligations. In contrast, displaying elements in a table form or through marking, for example, can suppress the steps required to grasp the foregoing information and save time. In addition, switching the item to be marked can display only the selected item, which makes it possible to more easily grasp the content of the selected item in comparison with when the item to be marked is not switched.

### Other Embodiments

The present invention is not limited to the foregoing embodiment, and can be modified in various ways within the scope of the present invention.

For example, the document information 111 may be a legal document or a document in other fields, such as an instruction manual. The present invention may be similarly applicable to such a document. In addition, the language of the document information 111 is not limited to Japanese or English, and the present invention is applicable to any other languages that can construct a sentence from which each element can be extracted. Each element is not limited to only the subject element, the defining element, or the limiting element, and may be a more specific element obtained by splitting each element into smaller pieces, or an element with a broader concept obtained by conceptualizing each element to a higher level, or may further include an element of a different type in addition to the foregoing elements.

In the foregoing embodiment, the function of each of the units 100 to 104 of the control unit 10 is implemented by a program, but some or all of the units may be implemented by hardware, such as an ASIC.

Alternatively, the program used in the foregoing embodiment may be provided by being stored in a recording medium, such as a CD-ROM. Further, the order of the steps described in the foregoing embodiment may be changed, or one or more of the steps may be removed, or further, (an)other step(s) may be added.

### [Notes]

The disclosed embodiment further discloses the following notes.

### (Note 1)

A document processing program for causing a computer to function as association means for outputting associated information obtained by associating a subject element and a defining element with each other and associating the defining element and a limiting element with each other based on a content of document information, the subject element being a character string representing a subject extracted from a character string of the document information, the defining element being a character string defining an operation and/or a state of the subject, and the limiting element being a character string limiting a content of the defining element.

### (Note 2)

The document processing program according to Note 1 above, for further causing a computer to function as display control means for displaying, based on the associated information, a relationship among the subject element, the defining element, and the limiting element in a table form.

### (Note 3)

The document processing program according to Note 1 above, for further causing a computer to function as display control means for displaying, based on the associated information, a relationship among the subject element, the defining element, and the limiting element in an emphasized manner on a screen displaying the document information.

### (Note 4)

The document processing program according to any one of Notes 1 to 3 above, in which the association means, in associating the subject element and the defining element with each other and associating the defining element and the limiting element with each other, does not perform association when a distance between character positions of the subject element and the defining element and a distance between character positions of the defining element and the limiting element are longer than a predetermined distance.

### (Note 5)

The document processing program according to any one of Notes 1 to 4 above, in which the computer is connected to one or more terminals via a network in a communicable manner.

### (Note 6)

The document processing program according to any one of Notes 1 to 5 above, in which the computer is connected to one or more terminals via a wireless communication network.

### (Note 7)

An information processing device including association means for outputting associated information obtained by associating a subject element and a defining element with each other and associating the defining element and a limiting element with each other based on a content of document information, the subject element being a character string representing a subject extracted from a character string of the document information, the defining element being a character string defining an operation and/or a state of the subject, and the limiting element being a character string limiting a content of the defining element.

### (Note 8)

An information processing device including a memory configured to store document information in addition to a predetermined instruction; and a processor configured to, based on the instruction stored in the memory, execute a process for outputting associated information obtained by associating a subject element and a defining element with each other and associating the defining element and a limiting element with each other based on a content of the document information, the subject element being a character string representing a subject extracted from a character string of the document information, the defining element being a character string defining an operation and/or a state of the subject, and the limiting element being a character string limiting a content of the defining element.

### (Note 9)

A document processing method including an association step of outputting associated information obtained by associating a subject element and a defining element with each other and associating the defining element and a limiting element with each other based on a content of document information, the subject element being a character string representing a subject extracted from a character string of the document information, the defining element being a character string defining an operation and/or a state of the subject, and the limiting element being a character string limiting a content of the defining element.

What is claimed is:

1. A computer-implemented method for document processing, wherein the method comprises:
one or more processors configured to:
recognize at least some of associated information based on a machine learning model, wherein the associated information comprises a subject element, and a defining element from a character string of document information, and wherein,
the subject element being a character string representing a subject extracted from a character string of the document information, and
the defining element being a character string defining a right and/or an obligation of the subject;
extract at least some of the associated information;
associate the subject element and the defining element with each other;
display, on a first display field of a computer screen, the document information; and
display, on a second display field of the computer screen, a character string of the right associated with the subject and/or a character string of the obligation associated with the subject for each subject element.

2. The computer-implemented method according to claim 1, one or more processors are configured to change a display mode according to the type of the associated information in the first display field.

3. The computer-implemented method according to claim 1, one or more processors are configured to display the associated information corresponding to a party concerned with the document information, and the associated information corresponding to another party concerned with the document information in different manners in the first display field.

4. The computer-implemented method according to claim 1, one or more processors are configured to switch a display mode of the associated information based on a user's operation.

5. The computer-implemented method according to claim 4, wherein the switching is per party concerned.

6. The computer-implemented method according to claim 1, one or more processors are configured to display, based on the associated information, a relationship among the subject element, and the defining element in an emphasized manner on the computer screen.

7. The computer-implemented method according to claim 1, wherein the association of the subject element and the defining element with each other is specified by not performing association when a distance between character positions of the subject element and the defining element is longer than a predetermined distance.

8. The computer-implemented method according to claim 1, one or more processors are configured to connect to the computer screen to a network in a communicable manner.

9. The computer-implemented method according to claim 1, one or more processors are configured to receive the document information form a terminal be operated by a user.

10. The computer-implemented method according to claim 1, wherein the document information is document information contained a document in the legal field.

11. The computer-implemented method according to claim 1, wherein
the document information is document information contained a contract; and
the subject element is parties described in the contract.

12. The computer-implemented method according to claim 1, one or more processors configured to display, on the second display field of the computer screen, the character string of the right associated with the subject and/or the character string of the obligation associated with the subject for each subject element in a list form.

13. An information processing device comprising:
one or more memories configured to store document information in addition to a predetermined instruction; and
one or more processors configured to:
recognize associated information in the stored document information based on a machine learning model, wherein the associated information comprises a subject element, and a defining element from a character string of document information, and wherein,
the subject element being a character string representing a subject extracted from a character string of the document information, and
the defining element being a character string defining a right and/or an obligation of the subject;
extract at least some of the associated information;
associate the subject element and the defining element with each other;
display, on a first display field of a computer screen, the document information; and
display, on a second display field of the computer screen, a character string of the right associated with the subject and/or a character string of the obligation associated with the subject for each subject element in a list form.

14. The information processing device according to claim 13, wherein the processor is further configured to change a display mode according to the type of the associated information in the first display field.

15. The information processing device according to claim 13, wherein the processor is further configured to display the associated information corresponding to a party concerned with the document information, and the associated information corresponding to another party concerned the document information in different manners in the first display field.

16. The information processing device according to claim 13, wherein the processor is further configured to switch a display mode of the associated information based on a user's operation.

17. The information processing device according to claim 16, wherein the switching is per party concerned.

18. The information processing device according to claim 13, wherein the processor is further configured to display, based on the associated information, a relationship among the subject element, and the defining element in an emphasized manner on the computer screen.
